(19) United States
(12) Patent Application Publication
(10) Pub. No.: US 2024/0167930 A1
(43) Pub. Date: May 23, 2024

(54) INTELLIGENT DUST ANALYSIS AND SUPPRESSION DURING ROAD HAULAGE OF MINING OUTPUT

(71) Applicant: INTERNATIONAL BUSINESS MACHINES CORPORATION, ARMONK, NY (US)

(72) Inventors: Niraj Ranjan SHARMA, Kolkata (IN); Jignesh K Karia, Thane (IN); Mukundan Sundararajan, Bangalore (IN)

(21) Appl. No.: 18/057,804

(22) Filed: Nov. 22, 2022

(51) Int. Cl. G01N 15/06; E01H 3/00; G06T 17/05

(52) U.S. Cl. CPC G01N 15/06; E01H 3/00; G06T 17/05; G01N 2015/0046

(57) ABSTRACT

According to one embodiment, a method, computer system, and computer program product for dust suppression is provided. The present invention may include collecting, from a plurality of sensors, environmental data pertaining to one or more monitored segments comprising a route; based on the environmental data and historical data, identifying a moisture level and a dust level of the one or more monitored segments; based on the environmental data and the historical data, extrapolating a moisture level and dust level of one or more unmonitored segments comprising the route; and based on the historical data, the moisture levels and the dust levels for the monitored segments and unmonitored segments, determining one or more abatement measures for the route.

### BACKGROUND

The present invention relates, generally, to the field of computing, and more particularly to dust abatement.

The field of dust abatement may be the field concerned with inhibiting the creation of excess soil dust, a pollutant which contributes to excess levels of particulate matter. Atmospheric or wind-borne fugitive dust comes from arid and dry regions where high velocity winds and/or anthropogenic disturbances are able to remove mostly silt-sized material, deflating susceptible surfaces. This includes areas where grazing, ploughing, vehicle use, and other human behaviors have further destabilized the land. One-third of the global land area is covered by dust-producing surfaces, made up of hyper-arid regions like the Sahara which covers 0.9 billion hectares, and drylands which occupy 5.2 billion hectares. Airborne dust produces a number of harmful effects, including health risks such as allergic reactions and respiratory diseases, environmental harm and reduced agricultural productivity, increased wear and maintenance requirements on vehicles resulting from clogged filters, bearings, and machinery, and decreased road traffic safety resulting from impaired visibility. As such, methods for preventing or decreasing the buildup of airborne dust stand to yield substantial benefits to human and environmental health and industrial and agricultural productivity.

### SUMMARY

According to one embodiment, a method, computer system, and computer program product for dust suppression is provided. The present invention may include collecting, from a plurality of sensors, environmental data pertaining to one or more monitored segments comprising a route; based on the environmental data and historical data, identifying a moisture level and a dust level of the one or more monitored segments; based on the environmental data and the historical data, extrapolating a moisture level and dust level of one or more unmonitored segments comprising the route; and based on the historical data, the moisture levels and the dust levels for the monitored segments and unmonitored segments, determining one or more abatement measures for the route.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a dust suppression process according to at least one embodiment;

FIG. 3 is a diagram illustrating an exemplary graphical user interface of a dust suppression system according to at least one embodiment; and

FIG. 4 is an exemplary implementation of dust suppression system according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to dust abatement. The following described exemplary embodiments provide a system, method, and program product to, among other things, capture input data comprising geographic, environmental, and anthropogenic data, utilize the Kriging method to extract dust data from the input data, and trigger targeted dust abatement actions based on the dust data.

As previously described, the field of dust abatement may be the field concerned with inhibiting the creation of excess soil dust, a pollutant which contributes to excess levels of particulate matter. Atmospheric or wind-borne fugitive dust comes from arid and dry regions where high velocity winds and/or anthropogenic disturbances are able to remove mostly silt-sized material, deflating susceptible surfaces. This includes areas where grazing, ploughing, vehicle use, and other human behaviors have further destabilized the land. One-third of the global land area is covered by dust-producing surfaces, made up of hyper-arid regions like the Sahara which covers 0.9 billion hectares, and drylands which occupy 5.2 billion hectares. Airborne dust produces a number of harmful effects, including health risks such as allergic reactions and respiratory diseases, environmental harm and reduced agricultural productivity, increased wear and maintenance requirements on vehicles resulting from clogged filters, bearings, and machinery, and decreased road traffic safety resulting from impaired visibility. As such, methods for preventing or decreasing the buildup of airborne dust stand to yield substantial benefits to human and environmental health and industrial and agricultural productivity.

The increased focus on environment compliance has led to many ways of monitoring and regulating the environment at mines and mineral/ore handling points. The dangerous emissions and dust generated due to mining operations has huge impact on the habitats, environment, and the equipment in the mines. The poisonous gases, mineral particles getting mixed in the water bodies, air and the food chain has highlighted the side effects and its impact. The dust is generated from vehicle movement on haulage roads, excavation, crushing, milling, conveyors belts, blasting, loading, unloading, wind erosions of stockpiles and overburden. The gases, harmful particles emanate from vehicles, beneficiation plants at the mines and material handling points at mines and ports. These dust and emissions are toxic in nature and impacts flora and fauna, soil, and air quality.

Even in non-arid environments, route condition may be difficult to manage, and dusty roads produce dust and gases which have the potential to harm workers and surrounding households. The current state of the art possesses no clear solution on how to manage the dust as the conditions that produce airborne dust are dynamic and could change hourly depending on dust, moisture, weather, and vehicle movements. Presently, solutions in the art seek to control airborne dust as a scheduled activity with process control systems and spray trucks. While mining/logistics/transportation companies try to spray the path and the air with suppressants such as water, the expense and logistical difficulty of spraying the entire length of a route with suppressants means that many resort to optimizations in an attempt to reduce the duration, area and/or amount of spray as well as, potentially, the number of trips needed on a particular route. For example, some attempted solutions utilize IoT sensors which are placed at intervals along a route to measure and report the dust. Based on the measurements, the spray vehicles or infrastructure is engaged. Some attempted solutions in the art seek to use weather readings to adjust vehicle movement based on natural atmospheric events; for example, by scheduling vehicle movement for periods after or during rainfall or during periods of high atmospheric humidity to reduce the amount of spraying needed. However, route conditions may be granular enough that comprehensive sensor coverage is required to accurately measure variations in local conditions due to weather or other factors. For long routes, such comprehensive sensor coverage may be expensive, prone to failure, or unfeasible; yet, if there are gaps in sensor coverage, measurements of nearby sensors may be extrapolated to segments of the route within the sensor gaps, resulting in a potentially incorrect assessment of the conditions within the sensor gap. Furthermore, current attempted solutions may measure air current systems across a roadway but fail to integrate analytics of the air current systems with other sensor data, thereby failing to take into account pockets of dust creation and transportation by an air system beyond the route. Incorrect or incomplete extrapolation of the dust conditions from local sensor data, weather conditions, operational effects, et cetera might result in an incorrect assessment of route conditions.

Additionally, current attempted solutions in the art may fail to utilize vehicle telematics or utilize vehicle telematics only to determine the general location of a vehicle on the route. However, additional road features and trip dynamics, such as the vehicle running on shoulders or curves of the road while passing, and/or the load movement of the vehicle, may influence the amount of dust created, for instance by raising additional dust from the shoulder of the road and/or the environment adjacent to the road; without taking such additional road features and trip dynamics into account, current attempted solutions may fail to accurately assess route conditions

Incorrect or inaccurate assessments of route conditions may result in portions of the route which are not sprayed or are not sprayed enough, resulting in the generation of dust pollution along segments of the route. Additionally, in some instances, portions of the route may be sprayed excessively, potentially resulting in environmental effects from runoff, and additional expense, as water is heavy and difficult to transport without dedicated infrastructure, and may be particularly valuable in arid environments where dust is most likely to be a problem.

As such, it may be advantageous to, among other things, implement a system that provides granular, real-time monitoring of dust, moisture, temperature, rain, operational activity, vehicle telematics including road features and/or trip dynamics, weather parameters including air systems, et cetera along or affecting a route, extrapolate and analyze the dust level and moisture level along the route based on the monitored conditions and historical data using machine learning processes to learn patterns and connections between the conditions, utilize the Kriging method to extrapolate dust and moisture levels at points along the route without sensor coverage, calculate moisture level required for dust suppression at specific areas along the route, and operate a dust suppression system to create the calculated moisture level.

Therefore, the present embodiment has the capacity to improve the technical field of dust abatement by taking into account an array of data sources including additional vehicle telematics and air systems and utilizing machine learning to effectively extrapolate gaps in sensor coverage and thereby accurately assess dust levels for an entire route even where sensor coverage of the route is not comprehensive; dust abatement efforts resulting from this more accurate assessment are more efficient and successful, which results in a number of additional advantages. For example, improving the treatment of routes increases the lifespan of the route, reducing the costs of haulage road maintenance; improved productivity resulting from the smooth movement of fleet equipment on routes which reduces the cycle time of vehicles such as haulers and dumpers; controlled and improved consumption of water and chemicals dust suppressants by identifying a specific location and amount to be sprayed, rather than performing a scheduled spray of chemicals evenly across the route; reduction in wear of tires through proper maintenance of routes, in some contexts including HEMM (Heavy Earth Moving Machinery) tires which are particularly costly; improved road safety by preventing or reducing the deterioration of routes through overspray of chemicals or water which may contribute to the creation of potholes, loose material, rutting, corrugation and slipper conditions which may result in near misses or accidents; effective and real-time utilization of dust abatement resources i.e. mobile spray tankers, stockpile spray system, operators, tankers through proper monitoring, forecasting and consumption of inventory of water and chemicals; real-time reduction of suspended dust particles which in turn reduces the chances of severe medical conditions in the long run for drivers and all those near the route; reducing wind erosion at stockpiles, loading points, unloading points, tailings, dams, ports, et cetera through appropriate dust abatement, et cetera.

According to one embodiment, the invention is a system that monitors environmental data in real-time using one or more sensors, analyzes the dust level and moisture level along monitored sections of the route based on the monitored data and historical data, extrapolates dust level and moisture level at one or more non-monitored sections of the route based on the monitored data and historical data, calculates moisture levels required for dust suppression at sections of the route based on the dust levels and moisture levels, and operates a dust suppression system to implement the calculated moisture level along the route.

The route may be a terrestrial pathway along which land-bound vehicles travel, such as a roadway, railway, haulage road, et cetera. The route may connect any two locations between which vehicles travel. The locations may include trailheads, roadheads, railheads, garages, motor pools, marshaling yards, stockpiles, loading points, unloading points, tailings dams, and docklands. The locations may comprise a source and a destination, such as a mine and a processing plant. In some embodiments of the invention, the route may comprise only the pathway between the locations. In some embodiments of the invention, for example where one or more of the locations are outdoors and/or may be subject to wind erosion or dust creation, the route may include the locations. The materials comprising the surface of the route, such as asphalt, paving stones, packed soil, wooden duckboards, steel rails on gravel railbed, concrete, et cetera may be pre-provided to the system. In some embodiments of the invention, the width of the route, including the presence and width of shoulders, type and composition of terrain flanking the route (grass, packed soil, sidewalks, stone, et cetera), historical paths taken by traffic along the route, et cetera may be pre-provided to the system. The route may be subdivided into segments based on sensor coverage; in some embodiments, for example where sensor coverage of the route is comprehensive, each segment comprises one or more sensors which record environmental data that relates to the length of the segment. The segment may be bounded in length by the effective range of one or more of the sensors comprising it, such that no part of the segment is outside of the sensor range of any or some sensors comprising, or in other words, disposed on, along, or otherwise geographically proximate to the segment. Such segments comprising sensors may be referred to as monitored segments. In some embodiments, the route may comprise segments that are not covered by some or any sensors; such segments may be referred to herein as unmonitored segments.

The environmental data may be all data relating to conditions and factors along a route or geographically proximate to a route from which a moisture level and/or dust level may be inferred. The environmental data may include data regarding the weather conditions affecting sections of the route, such as humidity, precipitation, temperature, wind speed and direction, air quality, et cetera. The environmental data may include operational data, which may include data recorded regarding vehicles traveling along the route, such as speed, acceleration, orientation, trip dynamics, and data regarding the operation of nearby dust-creating facilities such as pulverizing plants, strip mines, loading stations, et cetera. The environmental data may be collected from sensors disposed along the route, near the route, on or within vehicles, et cetera such that they can gather data relating to conditions and factors along the route or geographically proximate to a route. In some embodiments, environmental data may comprise externally recorded and/or received data that relates to conditions and factors along a route or geographically proximate to a route, such as weather forecasts from weather stations in the same region of the route, satellite imaging data of the route, et cetera.

Trip dynamics may include data pertaining to the maneuvers and operation of vehicles traveling the route, such as where a vehicle runs on shoulders on curves while passing and/or strays from the road, movement of load carried by vehicles, areas where the vehicle brakes, et cetera. Incorporating vehicle telematics provides the input of an unpredicted driving condition such as a sudden deceleration beyond a range, the amount of dust spillage due to road conditions such as swerving, driving on/outside the shoulder causing a jerkiness on the load, thus causing both the dust from the hauled minerals shifting in the truck to the spillage or a priorly spilled material on the road raising a dust. Also on the bends, the vehicle on the outer edge will need to move on the shoulder is there is a vehicle on the opposite lane and if that is with a trailer, the amount of movement can cause additional dust conditions.

The sensors may be devices capable of recording environmental data and communicating the recorded data over a network to the system. The sensors may be internet of things (IoT) sensors, which may be sensing devices comprising physical objects (or groups of such objects) equipped with processing ability, software, and other technologies that connect and exchange data with other devices and systems over the Internet or other communications networks. The sensors may, for example, comprise visual and infrared cameras, stationary, mobile, and satellite-based air quality sensors for measuring the presence and movement of dust; barometers, thermometers, hygrometers, anemometers, wind direction sensors, rain gauges, et cetera for measuring weather and moisture levels; and accelerometers, microlocation sensors such as near-field communications sensors, beacons, and Bluetooth, inclinometers, strain gauges, geo-location sensors such as GPS transceivers, et cetera for measuring the location, orientation, load position, movement, et cetera of a vehicle. The sensors may record data in real-time. Real-time, as referred to herein, may describe hardware and software system operation that is subject to a real-time constraint, for example from event to system response. Such real-time operations must guarantee a response within specified time constraints, which may be on the order of milliseconds, and sometimes microseconds. In some embodiments, for example where sensor readings are unlikely to fluctuate over periods of time and/or communication speeds are constrained by distance or infrastructure, the time constraints may rise to the order of seconds. Sensor readings may be taken in real time, and/or at regular intervals ranging from milliseconds to minutes, for example based on the speed with which a given sensor reading is likely to fluctuate and/or the importance of such a sensor reading in determining moisture or dust levels.

In some embodiments of the invention, the system may analyze the dust level and moisture level along monitored sections of the route based on the environmental data and historical data. The moisture level may be a number enumerating the total amount or proportion of water in its gaseous form present in the atmosphere at a given location. The moisture level may be influenced by rainfall, humidity, recent spraying, condensation, materials comprising the route, time of day, amount of sunlight, heat, et cetera. The dust level may be a number enumerating the total dust density in a given location, or in other words the amount or proportion of airborne dust in the atmosphere at that location. The dust level may be influenced by environmental data such as the operation of dust-producing equipment or facilities, high winds that blow over dusty terrain or facilities that produce dust, packed soil route or terrain surfaces, dust stirred up by the passage of different types of laden or unladen vehicles on the route at particular speeds or during particular maneuvers such as turns or movement onto the shoulders or terrain adjacent to the route, the shifting of dusty loads carried by vehicles, soil composition of the route and surrounding terrain, moisture level, et cetera. The moisture level and dust level may share an inverse relationship to each other, whereby as the water level increases the dust level decreases, and vice versa. The system may perform the analysis by providing the environmental data and historical data to a machine learning model, which may be trained on historical data to determine the water levels and dust levels that correspond with received combinations of environmental data. In determining the dust levels, the system may conduct an analysis of telematics and accelerometer readings to determine the level of unsettling of dust particles based on environmental data and determine the extent to which particles could become airborne based on the level of unsettling. The system may further model the wind patterns to identify where unsettled dust may be carried, and take the movement and path of wind-borne dust into account when determining the dust level for segments of the route.

Historical data may comprise environmental data collected beyond the real-time time constraints, and past connections identified between environmental data and moisture levels and dust levels. The historical data may also comprise the amount of different types of suppressants used to successfully abate dust in contexts comprising different dust levels and moisture levels, and other abatement techniques used successfully in differing dust levels and moisture levels. In some embodiments, historical data may comprise the effects of different types of suppressants on different environments and organisms, and/or abnormalities in environmental data that could correspond to operational or safety hazards.

In some embodiments of the invention, the system may extrapolate a dust level and moisture level at one or more non-monitored sections of the route based on the monitored data and historical data. The system may employ the Kriging method, by which interpolated values may be modelled by a Gaussian process governed by prior co-variances, to predict, based on historical data and the environmental data from monitored segments of the route, a dust level and moisture level at unmonitored segments of the route. The Kriging method can be understood as a two-step process: first, the spatial covariance structure of the sampled points, here environmental data from the monitored segments of the route, may be determined by fitting a variogram; and second, weights derived from this covariance structure may be used to interpolate values for unsampled points or blocks across the spatial field, here unmonitored segments of the route.

In some embodiments of the invention, the system may model and produce a visualization of the dust level and moisture level, which may comprise a three-dimensional view of dust and moisture content against the latitude and longitude of the route. Since extrapolation using the Kriging method allows the system to obtain dust and moisture levels at unmonitored segments of the route, the system may derive a visualization for the entire route including both monitored and unmonitored sections. The superimposition of dust and moisture plotting gives an idea and quantification of suppressants required at any specific location across the route. The united visualization and modeling of moisture and dust levels across the entire route may allow the system to make connections and identify patterns occurring at a scale encompassing the entire route, not just individual sections; for example, the system may identify the influence of movement of material in a truck traversing the route on dust levels, or may monitor route characteristics of unladen and laden trucks traversing the route to hyper localize the dust rising in the minerals based on the aggregate sizing considering the bends, road conditions and movement to shoulder along the route. The system may, for example, aggregate weather patterns and dust levels in segments affected by the weather patterns to predict where dust may be carried, and to predict where to spray suppressants to protect communities, environmental features such as waterways, and industrial operations from moving dust clouds. The system may further determine whether off-route spraying may be necessary. The system may model of hyper local air stream trends specific to the route area, for example through canyons or tunnels or around buildings, to predict dust levels and suppressant requirements. The system may model hyper local impacts of types of suppressants used based on the larger air patterns across the area.

In some embodiments of the invention, the system may calculate abatement measures required for dust suppression at segments of the route based on the environmental data, visualization, dust levels and moisture levels. The system may utilize a machine learning model to calculate, based on the moisture levels and dust levels, an amount of suppressant, a type or mixture of suppressant chemicals to use, a duration for which the suppressants should be sprayed, a time when the suppressant should be applied, et cetera. The machine learning model may, in some embodiments, further refine the accuracy of the abatement measures by taking into account environmental data comprising a moisture of pre-defined route surfaces, wind and temperature conditions on the road, vehicle telematics, et cetera to produce a multiple cluster output modeling the influence of route surface moisture and route shape and contouring on suppressant dispersion and flow, the influence of micro weather conditions and dust cloud size on suppressant dispersion and flow, the potential environmental impacts resulting from the different types, amounts, dispersion and flow of suppressants and proximity to water sources, the required dispersion and amount of suppressant to handle certain sizes of dust clouds, et cetera. The machine learning model may be initially trained using the historical data including measured moisture levels, predicted moisture levels, vehicle telematics, road contours to predict the flow and distribution of suppressant, the micro weather and resulting dust clouds, et cetera. The primary test data may be split in standard 70:30 ratio for training and testing. The suppressant (water & chemical) requirement may be defined as a function of moisture as follows:
W=f(1/m)
W=suppressant
m=moisture (The higher the moisture the lesser the quantity required)
n=nozzle rate 1/min
r=rain measure
la=latitude
ll=longitude
q=quality of material on which the spray will be done
t=time—mins, hour, shift
m=f(f,r,n,q,la,ll)
   Dust levels may be inversely proportional to moisture levels.

Abatement measures may be methods of inhibiting the creation of excess soil dust and other pollutants. The most common abatement measure is reactively or preventatively deploying suppressants; suppressants may be liquids that, when sprayed in the air, collect and trap airborne particulates through particle agglomeration and bring them to the ground, or, when sprayed on the ground, restrict the airborne dissemination of particles by the same method. The most common type of suppressant is water, but there are many other types including salts and brines, vegetable oils, petroleum derivatives, polymer emulsions, liquid polymers, lignosulfonates, surface active agents, bitumen emulsions, et cetera, which may be mixed with water or applied directly. Different types of suppressants excel in different conditions, and different types of suppressants potentially inflict varying environmental impacts by producing offensive odors, staining soil, poisoning groundwater, et cetera.

In some embodiments of the invention, the system may operate a dust suppression system to implement the calculated moisture level along the route. The dust suppression system may comprise reservoirs of suppressants attached to atomizing nozzles that spray a fine mist of water and/or other chemicals into the air. The dust suppression systems may be integrated into and/or transported by a vehicle such as a truck, plane, or helicopter, or may be integrated into stationary dust abatement infrastructure, for example mounted along the route such that mist from the nozzle can reach the route, and fed suppressants by hoses or pipes connected to suppressant tanks. In some embodiments, the atomizing nozzles may be computer controlled and may be directed or aimed by the system. The system may control the duration, amount, pressure, direction, elevation, chemical mixture, et cetera of the spray, and may be capable of dynamically tracking moving dust clouds with the atomizing nozzle to intercept wind-blown dust. The system may operate the dust suppression system based on the moisture level, dust level, and environmental data by, for example, mixing or selecting from suppressant chemicals available within the dust suppression system to minimize environmental impacts and/or improve dust suppression based on local conditions, scheduling sprays and/or the route and movement of dust-suppression-system-carrying vehicles to segments of the route where and when dust suppression is needed, and controlling one or more nozzles to spray the entirety of the segment and areas the system has identified as contributing to the dust level such as the shoulders and terrain adjacent to the route.

In some embodiments of the invention, the system will continue learning from the inputs provided by sensors after suppressant is sprayed to determine the effects of the spray on moisture levels and dust levels, and to assess the effectiveness of the spray and the accuracy of the machine learning engine's calculations and predictions.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to capture input data comprising geographic, environmental, and anthropogenic data, utilize the Kriging method to extract dust data from the input data, and trigger targeted dust abatement actions based on the dust data.

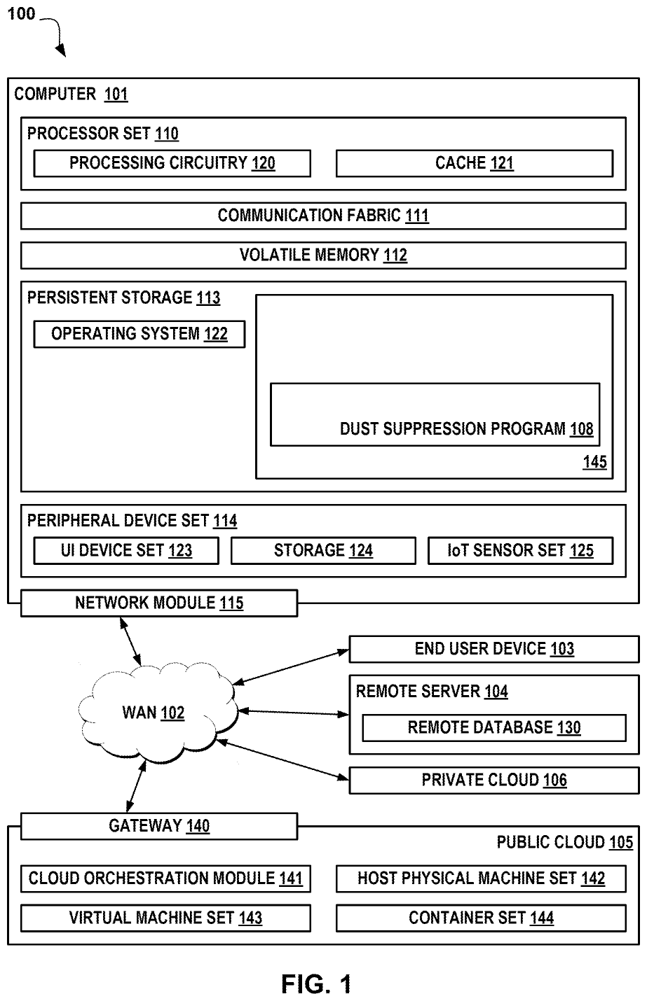

Referring now to FIG. 1, computing environment 100 contains an example of an environment for the execution of at least some of the computer code involved in performing the inventive methods, such as code block 145, which may comprise dust suppression program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

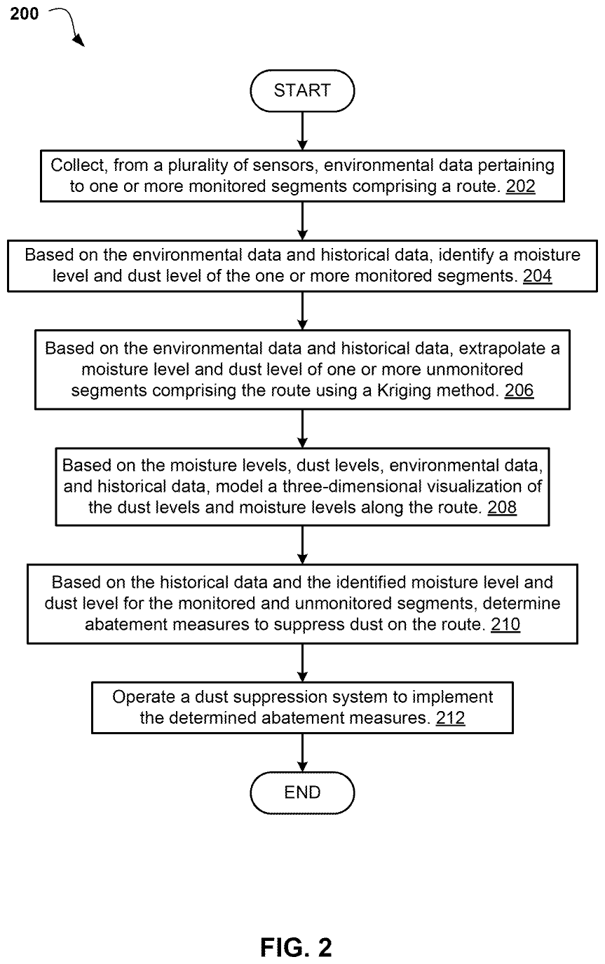

According to the present embodiment, the dust suppression program 108 may be a program capable of capture input data comprising geographic, environmental, and anthropogenic data, utilize the Kriging method to extract dust data from the input data, and trigger targeted dust abatement actions based on the dust data. The dust suppression program 108 may, when executed, cause the computing environment 100 to carry out a dust suppression process 200. The dust suppression process 200 may be explained in further detail below with respect to FIG. 2. In embodiments of the invention, the dust suppression program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, dust suppression program 108 may be distributed in its operation over any number or combination of the aforementioned devices.

Referring now to FIG. 2, an operational flowchart illustrating a dust suppression process 200 is depicted according to at least one embodiment. At 202, the dust suppression program 108 may collect, from a plurality of sensors, environmental data pertaining to one or more monitored segments comprising a route. The sensors may be devices capable of recording environmental data and communicating the recorded data over a network to the dust suppression program 108. The sensors may be internet of things (IoT) sensors, which may be sensing devices comprising physical objects (or groups of such objects) equipped with processing ability, software, and other technologies that connect and exchange data with other devices and systems over the Internet or other communications networks. The sensors may record data in real-time, and sensor readings may be taken in real time, and/or at regular intervals ranging from milliseconds to minutes, for example based on the speed with which a given sensor reading is likely to fluctuate and/or the importance of such a sensor reading in determining moisture or dust levels.

The environmental data may be all data relating to conditions and factors along a route or geographically proximate to a route from which a moisture level and/or dust level may be inferred. The environmental data may include data regarding the weather conditions affecting sections of the route; operational data, which may include data recorded regarding vehicles traveling along the route and data regarding the operation of nearby dust-creating facilities. The environmental data may be collected from sensors disposed along the route, near the route, on or within vehicles, et cetera such that they can gather data relating to conditions and factors along the route or geographically proximate to a route. In some embodiments, environmental data may comprise externally recorded and/or received data that relates to conditions and factors along a route or geographically proximate to a route.

The route may be a terrestrial pathway along which land-bound vehicles travel and may connect any two locations between which vehicles travel. In some embodiments of the invention, the route may comprise only the pathway between the locations, and in some embodiments, the route may further comprise the locations. The materials comprising the surface of the route may be pre-provided to the dust suppression program 108 by a user or virtual agent or crawled from a repository or service. In some embodiments of the invention, the width of the route, including the presence and width of shoulders, type and composition of terrain flanking the route (grass, packed soil, sidewalks, stone, et cetera), historical paths taken by traffic along the route, et cetera may be pre-provided to the dust suppression program 108. The route may be subdivided into segments based on static sensor coverage, or coverage of immobile sensors which are emplaced within the environment and not, for example, integrated or otherwise carried by a vehicle; in some embodiments, for example where static sensor coverage of the route is comprehensive, each segment comprises one or more static sensors which record environmental data that relates to the length of the segment. The segment may be bounded in length by the effective range of one or more of the static sensors comprising it, such that no part of the segment is outside of the sensor range of any or some static sensors comprising, or in other words, disposed on, along, or otherwise geographically proximate to the segment. Such segments comprising static sensors may be referred to as monitored segments. In some embodiments, the route may comprise segments that are not covered by some or any static sensors; such segments may be referred to herein as unmonitored segments.

At 204, the dust suppression program 108 may, based on the environmental data and historical data, identify a moisture level and dust level of the one or more monitored segments. The moisture level may be a number enumerating the total amount or proportion of water in its gaseous form present in the atmosphere at a given location. The dust level may be a number enumerating the total dust density in a given location, or in other words the amount or proportion of airborne dust in the atmosphere at that location. The moisture level and dust level may share an inverse relationship to each other, whereby as the water level increases the dust level decreases, and vice versa. The dust suppression program 108 may perform the analysis by providing the environmental data and historical data to a machine learning model, which may be trained on historical data to determine the water levels and dust levels that correspond with received combinations of environmental data. In determining the dust levels, the dust suppression program 108 may conduct an analysis of telematics and accelerometer readings to determine the level of unsettling of dust particles based on environmental data and determine the extent to which particles could become airborne based on the level of unsettling. The dust suppression program 108 may further model the wind patterns to identify where unsettled dust may be carried, and take the movement and path of wind-borne dust into account when determining the dust level for segments of the route.

Historical data may comprise environmental data collected beyond the real-time time constraints, and past connections identified between environmental data and moisture levels and dust levels. The historical data may also comprise the amount of different types of suppressants used to successfully abate dust in contexts comprising different dust levels and moisture levels, and other abatement techniques used successfully in differing dust levels and moisture levels. In some embodiments, historical data may comprise the effects of different types of suppressants on different environments and organisms, and/or abnormalities in environmental data that could correspond to operational or safety hazards.

At 206, the dust suppression program 108 may, based on the environmental data and historical data, extrapolate a moisture level and dust level of one or more unmonitored segments comprising the route using a Kriging method. The Kriging method is a method by which interpolated values may be modelled by a Gaussian process governed by prior co-variances, to predict, based on historical data and the environmental data from monitored segments of the route, a dust level and moisture level at unmonitored segments of the route. The Kriging method can be understood as a two-step process: first, the spatial covariance structure of the sampled points, here environmental data from the monitored segments of the route, may be determined by fitting a variogram; and second, weights derived from this covariance structure may be used to interpolate values for unsampled points or blocks across the spatial field, here unmonitored segments of the route.

At 208, the dust suppression program 108 may, based on the moisture levels, dust levels, environmental data, and historical data, model a three-dimensional visualization of the dust levels and moisture levels along the route. The visualization may comprise a three-dimensional view of dust and moisture content against the latitude and longitude of the route. Since extrapolation using the Kriging method allows the dust suppression program 108 to obtain dust and moisture levels at unmonitored segments of the route, the dust suppression program 108 may derive a visualization for the entire route including both monitored and unmonitored sections. The superimposition of dust and moisture plotting gives an idea and quantification of suppressants required at any specific location across the route. The united visualization and modeling of moisture and dust levels across the entire route may allow the dust suppression program 108 to make connections and identify patterns occurring at a scale encompassing the entire route, not just individual sections. The dust suppression program 108 may further determine whether off-route spraying may be necessary. The dust suppression program 108 may model hyper local air stream trends specific to the route area to predict dust levels and suppressant requirements. The dust suppression program 108 may model hyper local impacts of types of suppressants used based on the larger air patterns across the area.

At 210, the dust suppression program 108 may, based on the historical data, the visualization, identified moisture level and the dust level for the monitored and unmonitored segments, determine abatement measures to suppress dust on the route. The dust suppression program 108 may calculate abatement measures required for dust suppression at segments of the route based on the environmental data, visualization, dust levels and moisture levels. The dust suppression program 108 may utilize a machine learning model to calculate, based on the moisture levels and dust levels, an amount of suppressant, a type or mixture of suppressant chemicals to use, a duration for which the suppressants should be sprayed, a time when the suppressant should be applied, et cetera. The machine learning model may, in some embodiments, further refine the accuracy of the abatement measures by taking into account environmental data comprising a moisture of pre-defined route surfaces, wind and temperature conditions on the road, vehicle telematics, et cetera to produce a multiple cluster output modeling the influence of route surface moisture and route shape and contouring on suppressant dispersion and flow, the influence of micro weather conditions and dust cloud size on suppressant dispersion and flow, the potential environmental impacts resulting from the different types, amounts, dispersion and flow of suppressants and proximity to water sources, the required dispersion and amount of suppressant to handle certain sizes of dust clouds, et cetera. The machine learning model may be initially trained using the historical data including measured moisture levels, predicted moisture levels, vehicle telematics, road contours to predict the flow and distribution of suppressant, the micro weather and resulting dust clouds, et cetera. The primary test data may be split in standard 70:30 ratio for training and testing. In some embodiments the dust suppression program 108 may further determine opportunities to improve sustainability of abatement measures by taking into account environmental data to reduce the amount of spraying needed, for example by scheduling vehicles to travel the route after rainfall or when humidity is above a threshold that represents a moisture level that minimizes the chances of dust disturbance, or by selecting a combination of suppressants based on the area of a dust plume, and/or to reduce environmental impacts of the spray.

At 212, the dust suppression program 108 may operate a dust suppression system to implement the determined abatement measures. In some embodiments of the invention, the dust suppression program 108 may operate a dust suppression system to implement the calculated moisture level along the route. The dust suppression system may comprise reservoirs of suppressants attached to atomizing nozzles that spray a fine mist of water and/or other chemicals into the air. The dust suppression systems may be integrated into and/or transported by a vehicle or may be integrated into stationary dust abatement infrastructure, for example mounted along the route such that mist from the nozzle can reach the route, and fed suppressants by hoses or pipes connected to suppressant tanks. In some embodiments, the atomizing nozzles may be computer controlled and may be directed or aimed by the dust suppression program 108. The dust suppression program 108 may control the duration, amount, pressure, direction, elevation, chemical mixture, et cetera of the spray, and may be capable of dynamically tracking moving dust clouds with the atomizing nozzle to intercept wind-blown dust. The dust suppression program 108 may operate the dust suppression system based on the moisture level, dust level, and environmental data by, for example, mixing or selecting from suppressant chemicals available within the dust suppression system to minimize environmental impacts and/or improve dust suppression based on local conditions, scheduling sprays and/or the route and movement of dust-suppression-system-carrying vehicles to segments of the route where and when dust suppression is needed, and controlling one or more nozzles to spray the entirety of the segment and areas the dust suppression program 108 has identified as contributing to the dust level such as the shoulders and terrain adjacent to the route.

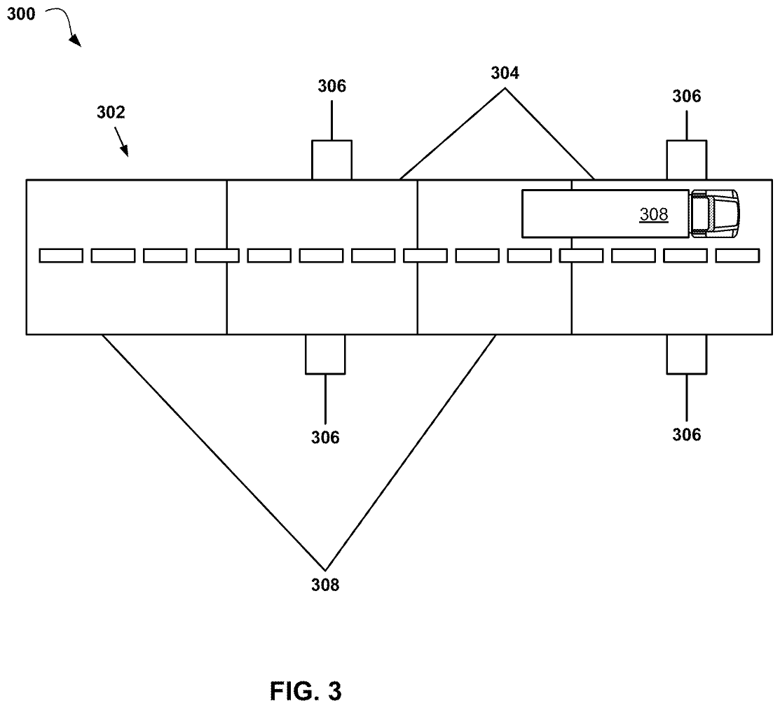

Referring now to FIG. 3, an exemplary implementation of a dust suppression system 300 is depicted according to at least one embodiment. Here, a portion of a route 302 is depicted, comprising four segments; two of the segments are monitored segments 304, comprising static sensors 306. Two of the segments are unmonitored segments 308, as they comprise no static sensors 306. A truck 308 is traveling the route, moving through an unmonitored segment 308 and monitored segment 304. The truck may comprise a number of mobile sensors measuring the trip telematics of the truck.

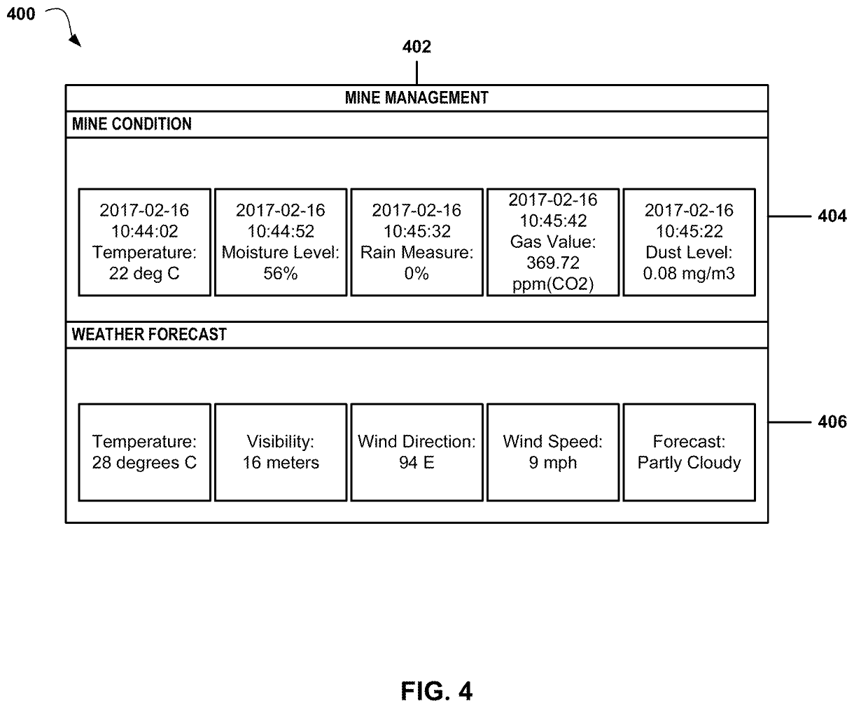

Referring now to FIG. 4, a diagram illustrating an exemplary graphical user interface 400 of a dust suppression program 200 is depicted according to at least one embodiment. Here, the route comprises a haul road which is part of a mine. The graphic user interface 400 comprises a mine management panel 402, which in turn comprises a mine condition panel 404 that displays a number of boxes depicting a range of environmental data including temperature, gas value, and rain measure, as well as the dust level and moisture level of a segment of the haul road comprising the mine. The mine management panel 402 further comprises a weather forecast panel 406 which displays a range of predicted information including predicted temperature, visibility, wind direction, wind speed, and forecast.

It may be appreciated that FIGS. 2-4 provide only illustrations of individual implementations and do not imply any limitations with regard to how different embodiments may be implemented. Many modifications to the depicted environments may be made based on design and implementation requirements. For example, while the specification largely discusses the dust suppression program 108 with reference to routes, one skilled in the art would understand the invention to additionally apply to contexts such as agriculture irrigation, where it may be used in profiling of moisture and water for optimal growth of plants; fire control, where it may be used for moisture and heat profiling to take pre-emptive measures; power plant coal handling plants, where it may be used for real time dust suppression and control; construction sites, where it may be used for real time dust suppression and control; et cetera by modifying, for example, the location of the sensors, the training data of the machine learning model, and the deployment methods and thresholds of water/suppressants.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for dust suppression, the method comprising:
collecting, from a plurality of sensors, environmental data pertaining to one or more monitored segments comprising a route;
based on the environmental data and historical data, identifying a moisture level and a dust level of the one or more monitored segments;
based on the environmental data and the historical data, extrapolating a moisture level and dust level of one or more unmonitored segments comprising the route; and
based on the historical data, the moisture levels and the dust levels for the monitored segments and unmonitored segments, determining one or more abatement measures for the route.

2. The method of claim 1, further comprising:
based on the moisture levels, the dust levels, the environmental data, and the historical data, modelling a three-dimensional visualization of the dust levels and moisture levels along the route.

3. The method of claim 1, further comprising:
operating a dust suppression system to implement the determined abatement measures.

4. The method of claim 1, wherein the extrapolating is performed by a machine learning model utilizing a Kriging method.

5. The method of claim 1, wherein the environmental data comprises trip dynamics including one or more vehicle interactions with a shoulder or adjacent terrain of the route.

6. The method of claim 1, wherein the determining comprises adjusting a suppressant spray based on contours of the route.

7. The method of claim 1, wherein the abatement measures are determined based on one or more environmental effects of one or more suppressants.

8. A computer system for dust suppression, the computer system comprising:
one or more processors, one or more computer-readable memories, one or more sensors, one or more computer-readable tangible storage medium, and program instructions stored on at least one of the one or more tangible storage medium for execution by at least one of the one or more processors via at least one of the one or more memories, wherein the computer system is capable of performing a method comprising:
collecting, from a plurality of sensors, environmental data pertaining to one or more monitored segments comprising a route;
based on the environmental data and historical data, identifying a moisture level and a dust level of the one or more monitored segments;
based on the environmental data and the historical data, extrapolating a moisture level and dust level of one or more unmonitored segments comprising the route; and
based on the historical data, the moisture levels and the dust levels for the monitored segments and unmonitored segments, determining one or more abatement measures for the route.

9. The computer system of claim 8, further comprising:
based on the moisture levels, the dust levels, the environmental data, and the historical data, modelling a three-dimensional visualization of the dust levels and moisture levels along the route.

10. The computer system of claim 8, further comprising:
operating a dust suppression system to implement the determined abatement measures.

11. The computer system of claim 8, wherein the extrapolating is performed by a machine learning model utilizing a Kriging method.

12. The computer system of claim 8, wherein the environmental data comprises trip dynamics including one or more vehicle interactions with a shoulder or adjacent terrain of the route.

13. The computer system of claim 8, wherein the determining comprises adjusting a suppressant spray based on contours of the route.

14. The computer system of claim 8, wherein the abatement measures are determined based on one or more environmental effects of one or more suppressants.

15. A computer program product for dust suppression, the computer program product comprising:
one or more computer-readable tangible storage medium and program instructions stored on at least one of the one or more tangible storage medium, the program instructions executable by a processor to cause the processor to perform a method comprising:
collecting, from a plurality of sensors, environmental data pertaining to one or more monitored segments comprising a route;
based on the environmental data and historical data, identifying a moisture level and a dust level of the one or more monitored segments;
based on the environmental data and the historical data, extrapolating a moisture level and dust level of one or more unmonitored segments comprising the route; and
based on the historical data, the moisture levels and the dust levels for the monitored segments and unmonitored segments, determining one or more abatement measures for the route.

16. The computer program product of claim 15, further comprising:
based on the moisture levels, the dust levels, the environmental data, and the historical data, modelling a three-dimensional visualization of the dust levels and moisture levels along the route.

17. The computer program product of claim 15, further comprising:
operating a dust suppression system to implement the determined abatement measures.

18. The computer program product of claim 15, wherein the extrapolating is performed by a machine learning model utilizing a Kriging method.

19. The computer program product of claim 15, wherein the environmental data comprises trip dynamics including one or more vehicle interactions with a shoulder or adjacent terrain of the route.

20. The computer program product of claim 15, wherein the determining comprises adjusting a suppressant spray based on contours of the route.
